(19) United States
(12) Patent Application Publication
(10) Pub. No.: US 2025/0149319 A1
(43) Pub. Date: May 8, 2025

(54) SYSTEMS AND METHODS FOR IMPROVING ANALYSIS OF CHARGE SERIES SPECTRA

(71) Applicant: DH Technologies Development Pte. Ltd., Singapore (SG)

(72) Inventor: Lyle Lorrence BURTON, Woodbridge (CA)

(73) Assignee: DH Technologies Development Pte. Ltd., Singapore (SG)

(21) Appl. No.: 18/837,043

(22) PCT Filed: Feb. 10, 2023
(86) PCT No.: PCT/IB2023/051214

§ 371 Date: Aug. 8, 2024

Related U.S. Application Data
(60) Provisional application No. 63/308,796, filed on Feb. 10, 2022.

(51) Int. Cl. H01J 49/00

(52) U.S. Cl. CPC H01J 49/0036

(57) ABSTRACT

A method and system include receiving a charge series spectrum having charge series peaks, determining reconstructed mass values based on the received charge series spectrum, displaying the reconstructed mass values, receiving a selection of a displayed reconstructed mass value, and displaying a plurality of icons including a marker and a corresponding charge series peak, the marker identifying a charge of the spectrum. Another method and system include receiving a charge series spectrum having charge series peaks, determining reconstructed mass values based on the received charge series spectrum, and for each reconstructed mass value, determining a plurality of markers corresponding to charges of the charge series and having a corresponding charge series peak, and determining that the reconstructed mass value is a probable artifact when a difference between one of the markers and a local maximum of the corresponding charge series peak is greater than a threshold.

### CROSS-REFERENCE TO RELATED APPLICATIONS

This application is being filed on Feb. 10, 2023, as a PCT International Patent Application that claims priority to and the benefit of U.S. Provisional Application Ser. No. 63/308,796, filed Feb. 10, 2022, the disclosure of which is hereby incorporated by reference in its entirety.

### BACKGROUND

Mass spectrometry (MS) is an analytical technique that is used to measure the mass-to-charge ratio of ions in order to identify molecules, or fragments of molecules, in a sample. The results are presented as a mass spectrum, which is a type of plot of the ion signal intensity (counts per second or cps) as a function of the mass-to-charge ratio (m/z). Mass spectra are typically used to determine the elemental or isotopic signature of a sample, the masses of particles and of molecules or fragments thereof, and to elucidate the chemical identity or structure of molecules and other chemical compounds. Mass spectrometry is used in many different fields and is applied to pure samples as well as complex mixtures. Not all mass spectra of a given substance are the same. For example, some mass spectrometers break the analyte molecules into fragments, others observe the intact molecular masses with little fragmentation. A mass spectrum can represent many different types of information based on the type of mass spectrometer and the specific experiment applied.

### SUMMARY

In an example aspect, a method of displaying a charge series spectrum includes receiving the charge series spectrum, the charge series spectrum including a plurality of charge series peaks, determining one or more reconstructed mass values based at least in part on the received charge series spectrum, displaying the one or more reconstructed mass values on a first portion of a display, receiving a selection of one of the displayed reconstructed mass values, and displaying a plurality of icons on a second portion of the display, each icon including a marker and a corresponding charge series peak thereof, the marker identifying a charge of the charge series spectrum.

In another example of the above aspect, the method further includes displaying the charge series spectrum on a third portion of the display. In yet another example, the method further includes displaying the plurality of icons comprises displaying each icon with an enlarged view of the marker and of the corresponding peak thereof compared to the charge series spectrum. In another example, displaying the one or more reconstructed mass values includes displaying a reconstructed spectrum, the reconstructed spectrum including reconstructed peaks corresponding to the one or more reconstructed mass values.

In another example of the above aspect, displaying the one or more reconstructed mass values includes displaying a list of the one or more reconstructed mass values and their corresponding signal intensities. In yet another example, the method further includes determining, for each icon, whether a local maximum of the charge series peak and the corresponding marker coincide with each other. In another example, the method further includes determining that the selected reconstructed mass value is an artifact when the marker does not coincide with a local maximum of the corresponding charge series peak thereof in at least one of the plurality of icons. In yet another example, the method further includes displaying a reconstructed spectrum on the display without the artifact. In another example, the method further includes displaying a list of the one or more reconstructed mass values and their corresponding signal intensities, the list omitting the artifact.

In another example of the above aspect, determining that the marker does not coincide with the local maximum of the corresponding charge series peak includes determining that a separation between the marker and the local maximum of the corresponding charge series peak is greater than a percentage of a width of the corresponding charge series peak, the percentage being, e.g., 25%. In yet another example, determining that the marker does not coincide with the local maximum of the corresponding charge series peak includes determining that a separation between the marker and the local maximum of the corresponding charge series peak is greater than a percentage of a full width at half-maximum of the corresponding charge series peak. In a further example, displaying the plurality of icons includes displaying a central icon and other icons in proximity to the central icon, and a corresponding peak of the central icon has a highest signal intensity compared to corresponding peaks of the other icons.

In another aspect, a mass spectrometry data display apparatus includes a data receiver, a display device functionally coupled to the data receiver, the display device comprising a display screen, a processor operatively coupled to the data receiver and to the display device, and a memory coupled to the processor, the memory storing instructions. The instructions, when executed by the processor, perform a set of operations including receiving, at the data receiver, a charge series spectrum including a plurality of charge series peaks, generating, via the processor, one or more reconstructed mass values based at least in part on the received charge series spectrum, displaying the one or more reconstructed mass values on a first portion of the display screen, receiving, at the display screen, a selection of one of the displayed reconstructed mass values, and displaying a plurality of icons on a second portion of the display screen, each icon including a marker and a corresponding charge series peak thereof, the marker identifying a charge of the charge series spectrum.

In an example of the above aspect, displaying the one or more reconstructed mass values comprises displaying a reconstructed spectrum, the reconstructed spectrum including reconstructed peaks corresponding to the one or more reconstructed mass values. In another example, displaying the one or more reconstructed mass values comprises displaying a list of the one or more reconstructed mass values and their corresponding signal intensities. In yet another example, the set of operations further includes determining, via the processor, that the selected reconstructed mass value is an artifact when the marker does not coincide with a local maximum of the corresponding charge series peak thereof in at least one of the plurality of icons.

In a further example of the above aspects, the set of operations further includes displaying a reconstructed spectrum on the display screen without the artifact. In another example, the set of operations further includes displaying a list of the one or more reconstructed mass values and their corresponding signal intensities on the display screen, the list omitting the artifact. In yet another example, the set of operations includes determining, via the processor, that the marker does not coincide with the local maximum of the corresponding charge series peak when a separation between the marker and the local maximum of the corresponding charge series peak is greater than a percentage of a width of the corresponding peak. In yet another example, the set of operation includes displaying, on the display screen, each icon on the display screen with an enlarged view of the marker and of the corresponding peak thereof compared to the charge series spectrum. In another example, displaying the plurality of icons includes displaying a central icon and other icons in proximity to the central icon, and a corresponding charge series peak of the central icon has a highest signal intensity compared to corresponding charge series peaks of the other icons.

In another example aspect, a method of evaluating the quality of a charge series spectrum includes receiving the charge series spectrum, the charge series spectrum including a plurality of charge series peaks, generating one or more reconstructed mass values based at least in part on the received charge series spectrum, and for each reconstructed mass value, the method includes: generating a plurality of markers, each marker corresponding to a charge of the charge series and having a corresponding charge series peak thereof from the charge series spectrum, and determining that the reconstructed mass value is an artifact when a difference between at least one of the plurality of markers and a local maximum of the corresponding charge series peak thereof is greater than a threshold.

In an example of the above aspect, the method further includes providing a list of the one or more reconstructed mass values without the artifact. For example, providing the list includes displaying the list on a display. In yet another example, the method further includes providing a reconstructed spectrum, the reconstructed spectrum including reconstructed peaks corresponding to the one or more reconstructed mass values. In a further example, the provided reconstructed spectrum does not include the artifact. For example, providing the reconstructed spectrum includes displaying the reconstructed spectrum on a display.

### BRIEF DESCRIPTION OF THE DRAWINGS

FIG. 1 is a schematic view of a mass spectrometer.

FIG. 2 is a schematic diagram of a charge series spectrum in accordance with various embodiments described herein.

FIG. 3 illustrates a reconstructed spectrum according to various aspects.

FIGS. 4A-4E are illustrations of a peak analysis display, according to various aspects.

FIGS. 5A-5B are illustrations of a peak analysis display, according to various aspects.

FIGS. 6A-6B are flow charts depicting methods for analyzing a mass spectrometry spectrum, in accordance with various embodiments described herein.

FIG. 7 depicts a block diagram of a computing device.

### DETAILED DESCRIPTION

Charge series spectra are spectra that include multiple mass-to-charge ratio (m/z) peaks for the same component. Such spectra contain multiple peaks for each component depending on the number of charges (z). Within a single spectrum, multiple series for different components (e.g., different glycoforms of a protein) are typically present because these components are typically not well resolved by techniques such as, e.g., chromatography. As such, various algorithms are typically used to deconvolute, also referred to as reconstruct, charge series spectra and generate a reconstructed spectrum including a plurality of reconstructed peaks. Such reconstructed may be true peaks, e.g., may represent an actual compound, or may be artifacts generated by the deconvolution algorithms. For example, the algorithms sometimes generate artifacts, which are reconstructed peaks that do not actually correspond to a given component, but that are artificially created during the generation of the reconstructed spectrum. These artifacts are sometimes related to harmonics, off-by-one charge errors, and the like. As a result, users typically spend considerable time manually confirming whether a given reconstructed peak is representative of a molecule or fragment thereof, or an artifact. In examples, if a reconstructed peak is, in fact, representative of a molecule or fragment thereof, it may be referred to as a “true peak.” For clarity, the term “true peak” is used herein.

Manual confirmation of whether a reconstructed peak is a true peak or an artifact is typically performed by a user manually magnifying the m/z axis of a charge series spectrum display of the charge series peaks that are correlated to the reconstructed peak so that the peak shapes and positions can be seen for various charge states at various mass-to-charge ratios. Especially for cases where the data are complex and/or noisy, this can require considerable manual manipulation of the display by a user, e.g., by zooming in and zooming out of the spectrum display as multiple m/z peaks are individually examined.

Accordingly, there is technical problem in that the considerable manual zooming in and zooming out by a user to examine multiple m/z peaks correlated to a reconstructed peak causes a significant loss of time. To solve this technical problem, a solution includes generating and providing the user with “thumbnail” spectra, or icons, for one or more of the charge states which are already zoomed or magnified to the correct ranges, e.g., ranges that allow the user to visually determine whether a m/z peak is representative of a compound or whether it is an artifact. As such, for example, the user may save a significant amount of time analyzing a charge series spectrum because they would no longer have to manually zoom in and zoom out of the various charge series peaks. Another solution to solve this technical problem includes automatically determining the separation between the various charge series peaks correlated to each reconstructed peak and the position of each charge of the charge series. Accordingly, when the distance separating a peak and a charge is greater than a threshold, which may be previously established, then it can be concluded that the reconstructed peak that is correlated to the peak is an artifact. If the distance is equal to or smaller than the threshold for all the m/z peaks correlated to a given reconstructed peak, then it can be concluded that the reconstructed peak is a true peak.

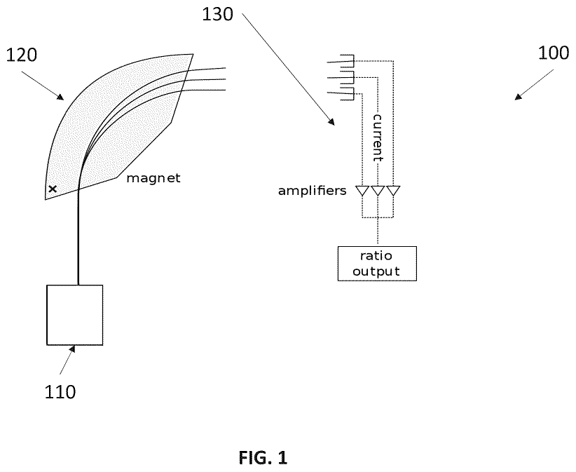

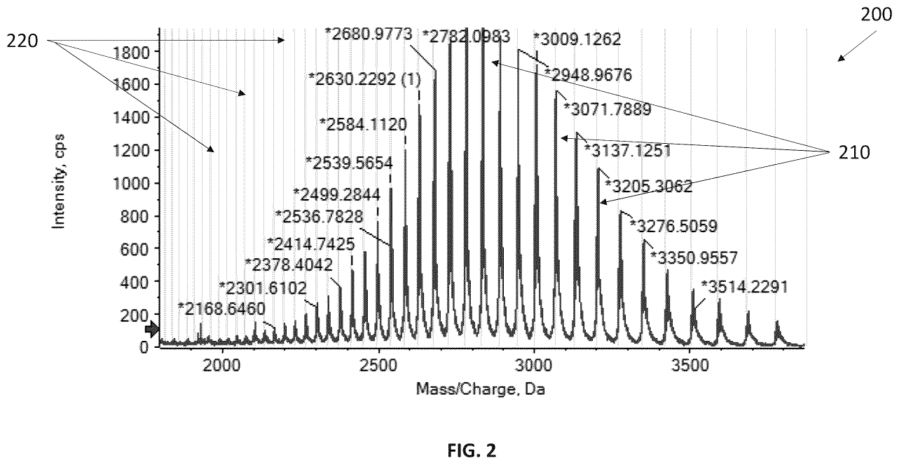

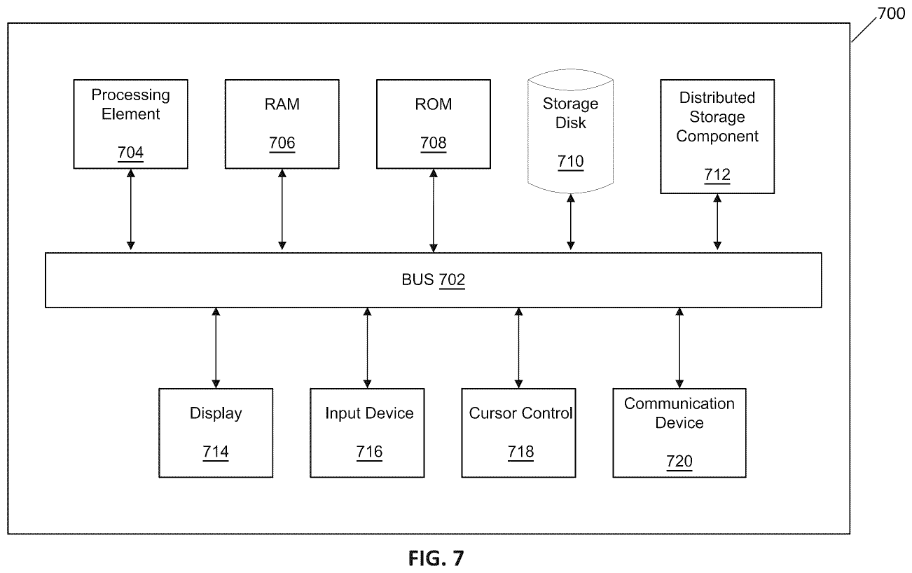

For illustrative purposes, FIG. 1 is a schematic view of an example mass spectrometer 100. In FIG. 1, the example mass spectrometer 100 includes three components: an electron source 110, a mass analyzer 120, and a detector 130. For example, in a typical MS procedure, a sample, which may be solid, liquid, or gaseous, is ionized, for example by bombarding it with a beam of electrons from electron source 110. Bombarding the sample may cause the sample to become positively charged, or molecules of the sample to vaporize and break up into positively charged fragments. The positively charged ions or fragments are then separated according to their mass-to-charge ratio, for example by accelerating them and subjecting them to an electric or magnetic field from, e.g., a magnet 120. As a result, fragments or ions having the same mass-to-charge ratio may undergo the same amount of deflection. When deflected, the ions are detected by a detector 130 that is capable of detecting charged particles. The detector 130 may be, e.g., an electron multiplier. The results of the detection may be displayed as a spectrum of the signal intensity of detected ions as a function of the mass-to-charge (m/z) ratio, as indicated below with respect to FIG. 2. The atoms or molecules in the sample can be identified by correlating known masses (e.g., an entire molecule) to the identified masses or through a characteristic fragmentation pattern. Operation of the example mass spectrometer 100 may be controlled by a computing device such as, e.g., the computing device 700 illustrated in FIG. 7 and further discussed below, the computing device including a processor and a data repository.

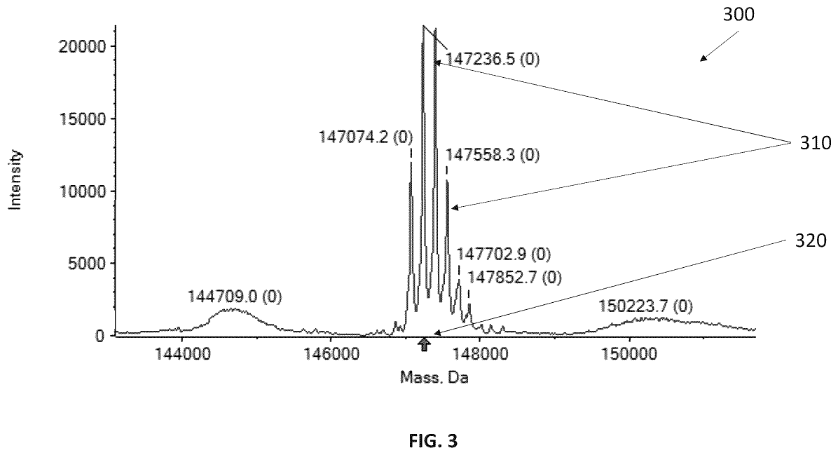

FIG. 2 is a schematic diagram of a charge series spectrum in accordance with various embodiments described herein. In particular, FIG. 2 illustrates a raw charge series (m/z) spectrum 200 obtained from a mass spectrometer such as, e.g., the example mass spectrometer 100 discussed above with respect to FIG. 1. Spectrum 200 includes a plurality of peaks 210, each peak 210 corresponding to the ratio of mass over the charge for either a compound or a fragment of the compound. The raw data does not plot mass as a function of intensity, but mass divided by charge as a function of intensity, and because a number of different charges may be generated for the same molecule, particularly a large molecule, the charge series spectrum 200 may include a large number of peaks that correspond to the same molecule or fragment of molecule. As such, the number of peaks may be larger than the actual number of molecules or fragments thereof. FIG. 2 also includes a plurality of markers 220 that are overlayed on the charge series spectrum 200, each marker being indicative of a charge of the charge series, as will further be discussed below with respect to FIG. 3. In various aspects, a charge series peak that is the result of a molecule bombardment may coincide with a given charge on the x-axis of the charge series spectrum 200.

FIG. 3 illustrates a reconstructed spectrum according to various aspects. In FIG. 3, the reconstructed spectrum 300 is generated based at least in part on the charge series spectrum 200 discussed above with reference to FIG. 2. Specifically, the x-axis in FIG. 3 plots the mass (Da), instead of the ratio of mass over charge (m/z) as in FIG. 2. The reconstructed spectrum is generated by plotting the signal intensity with respect to the mass by taking into account the charges of the molecules or fragments thereof. The mass-to-charge ratio is typically calculated as m/z=Total Mass/z, where z is the charge, which is also expressed as m/z=(Mass M+z*Mass of charge agent)/z, and the charge agent typically has a mass that is close to 1.0. As such, the mass-to-charge ratio m/z=(Mass M+z)/z, and Mass M=(m/z)*z−z. Thus, for example, for a peak at a m/z value of 2780 in FIG. 2, for a charge z of, e.g., 53, the resulting deconvoluted or reconstructed peak would be a peak at a mass of (2780×53−53=) 147,287 Da. There may be other peaks in the charge series spectrum illustrated in FIG. 2 that would generate the same peak at 147,340 Da in the reconstructed spectrum because they correspond to the same molecule or molecule fragment, in which case these other peaks may be merged into the same peak in FIG. 3. Accordingly, FIG. 3 illustrates reconstructed peaks 310 based at least in part on the charge series spectrum 200 illustrated in FIG. 2.

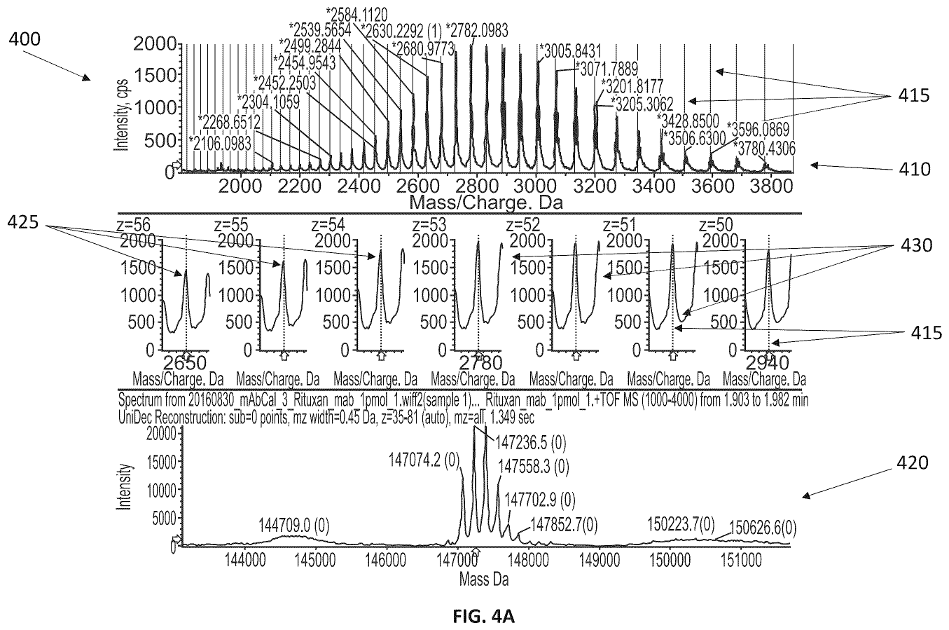

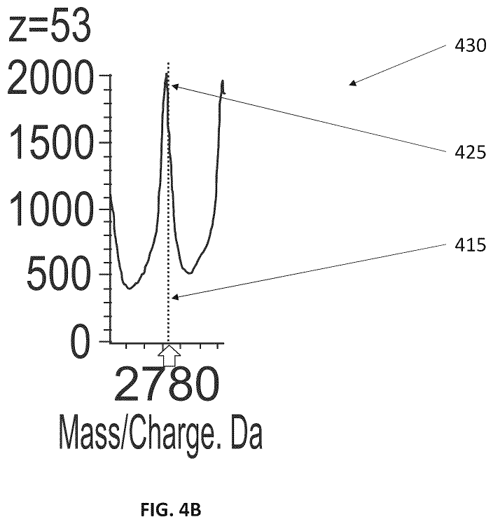

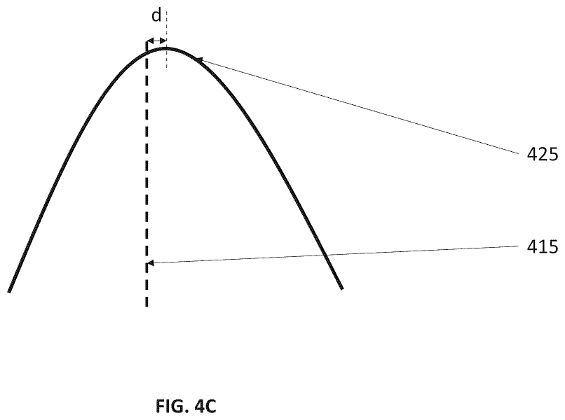

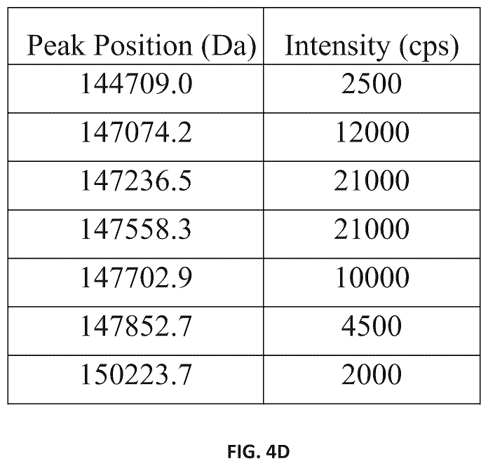

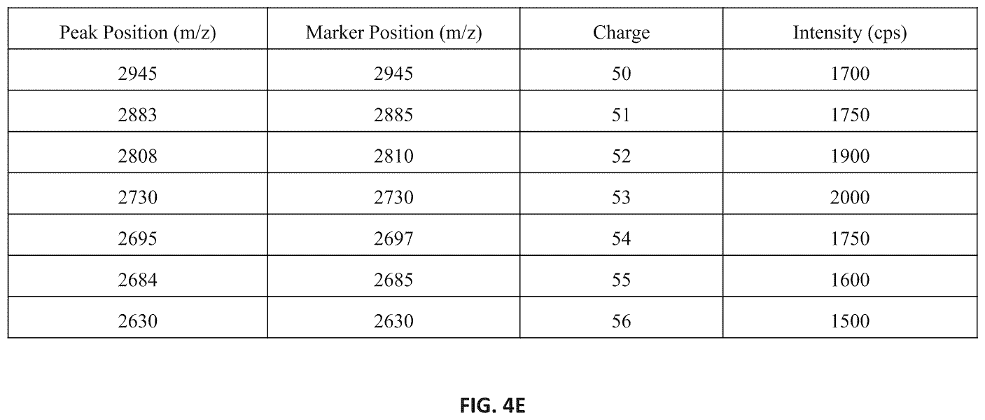

In various aspects, in order to determine whether a given reconstructed peak such as, e.g., a peak 310 in FIG. 3, represents a molecule or molecule fragment, or whether it is an artifact, a user may enter a selection 320 of one of the reconstructed peaks 310 to further examine the reconstructed peak 310. When the selection 320 is entered on the reconstructed spectrum 300, as further illustrated in FIG. 4, markers 415 indicative of the various charges are overlayed on the charge series spectrum.

FIGS. 4A-4E are illustrations of a charge-series spectrum analysis display, according to various aspects. In FIG. 4A, the charge-series spectrum analysis display 400 includes three (3) portions: the raw charge-series spectrum 410, similar to the raw spectrum 200 discussed above with respect to FIG. 2, the deconvoluted or reconstructed spectrum 420, similar to the reconstructed spectrum 300 discussed above with reference to FIG. 3, and a plurality of icons 430. In various aspects, when a selection of one of the reconstructed peaks of the reconstructed spectrum 420 is entered, as discussed above with reference to FIG. 3, the markers 415 are overlayed over the charge series spectrum 410, each marker 415 corresponding to a charge. In addition, a plurality of icons 430 are displayed, each of the icons 430 illustrating charge-series peaks 425 which are correlated to the selected reconstructed peak. Specifically, the charge-series peaks 425 correspond to the selected reconstructed peak at different charges, the charges being indicated by the markers 415. Accordingly, the user may be able to visually see at the icons 430, for each charge of the charge series, whether the charge-series peak 425 coincides with its corresponding marker 415. Displaying the icons 430 facilitates the determination by the user of whether the charge series peak 425 and the marker 415 coincide with each other because the user may no longer have to manually magnify, or zoom, each charge series peak of the charge series spectrum 410 to determine whether the marker coincides with the charge series peak.

In various aspects, each of the icons 430 indicates a given charge, illustrated in FIG. 4A as ranging from 50 to 56. Accordingly, for each charge, the user is able to determine whether the charge series peak coincides with the marker 415, as further discussed below.

In FIG. 4B, due to the icon 430 displaying a magnified view of the charge series peak 425 and its corresponding marker 415, it is easier to visually determine whether the charge series peak 425 coincides with the marker 415. Specifically, a user may determine via visual inspection that, in the example illustrated in FIG. 4B, the charge series peak 425 coincides fairly closely with the marker 415. More specifically, determining whether the charge series peak 425 coincides with the marker 415 is performed by evaluating the distance between the charge series peak 425 and the marker 415, as discussed in greater detail below.

In various aspects, FIG. 4C illustrates an example determination of whether the charge series peak 425 coincides with its corresponding marker 415. When the determination is made by a user, as discussed above with respect to FIGS. 4A and 4B, the user visually estimates the distance, illustrated in FIG. 4C as “d,” that separates the marker 415 from the top of the charge series peak 425 in a direction parallel to the x-axis of the charge series spectrum. If the user is satisfied that the distance “d” is within an acceptable range, the user may determine that the charge series peak 425 and the marker 415 do coincide with each other, and thus that the charge series peak 425 is representative of a molecule or molecule fragment. In various aspects, the user may measure the distance “d” and compare the measured distance to a previously determined threshold to assess whether the charge series peak coincides with the marker. The user may make a simple visual determination of whether the charge series peak coincides with the maker, measure the distance “d” directly on the display screen, or use a screen application capable of measuring the distance between two points on the screen.

In various aspects, instead of visually determining whether the distance “d” that separates the charge series peak 425 from the marker 415 is within an acceptable range, the distance “d” may be automatically calculated without displaying the charge series spectrum 410, the reconstructed spectrum 420 or the icons 430. As such, a distance threshold may first be established, and then the automatically calculated distance “d” may be compared to that threshold. For example, if the automatically calculated distance “d” is equal to or smaller than the threshold, then the charge series peak 425 and the marker 415 may be considered to coincide with each other. If the distance “d” is greater than the threshold, then the charge series peak 425 and the marker 415 may be considered to not coincide with each other. In various aspects, this manner of determining whether the charge series peak 425 and the marker 415 coincide with each other does not require a visual evaluation by a user or a display of any of the spectra and icons described in reference to FIG. 4A. In various aspects, the above evaluation based on the automatic calculation of the distance “d” may be performed for each of the charge series peaks corresponding to each of the reconstructed peaks without the need for receiving a selection of one of the reconstructed peaks by the user discussed with reference to FIG. 4A.

In various aspects, instead of displaying a charge-series spectrum such as the charge series spectrum 410 and a reconstructed spectrum such as reconstructed spectrum 420, a charge series table and a reconstructed table may be displayed. For example, a charge series table may include the peak positions of the charge series spectrum (m/z), the positions of their corresponding markers, and their corresponding signal intensities. In other aspects, a reconstructed table may include the peak positions of the reconstructed spectrum (m) and their corresponding intensities. Examples of such tables are provided in FIGS. 4D and 4E, which illustrate the same spectra as in FIG. 4A.

FIG. 4D illustrates a reconstructed table, according to various aspects. In various aspects, in FIG. 4D, the peak positions and their corresponding intensities are the same as the peak positions and intensities displayed in the reconstructed spectrum 420 of FIG. 4A. In various aspects, the user may select any one of the peaks from the charge series spectrum 410 in FIG. 4A, either via a GUI or by entering the peak position, and the reconstructed table illustrated in FIG. 4D may be generated. In various aspects, the various peak positions listed in the table at FIG. 4D represent the positions of the reconstructed peaks such as, e.g., the reconstructed peaks 420 illustrated in FIG. 4A. In various aspects, when one of the peak positions of the reconstructed table illustrated in FIG. 4D is selected by a user, either via a GUI or by entering the peak position, then another table may be displayed, the table including peaks corresponding to the icons 430 illustrated in FIG. 4A. For example, when the peak position 147236.5 in the table illustrated in FIG. 4D is selected by the user, the charge series peak that correspond to that reconstructed peak may be displayed in another table, as further discussed below.

FIG. 4E illustrates a charge series table, according to various aspects. For example, the peak positions in the table illustrated in FIG. 4E, and their corresponding intensities, are the same as the peak positions and intensities displayed in the icons 430 of FIG. 4A. In some aspects, based on the table illustrated in FIG. 4E, it is possible to determine that all the charge-series peaks coincide almost exactly with the marker positions without having to visually estimate the degree of coincidence therebetween. For example, some of the charge-series peaks, e.g., for charges 51, 52, 54 and 55, are offset from their corresponding marker positions by a distance that falls under a threshold distance and can thus be considered to coincide with each other. The charge-series peaks for charges 50, 53 and 56 coincide exactly with the marker positions. Accordingly, the reconstructed table illustrated in FIG. 4E indicates that the charge series peak selected from the table illustrated in FIG. 4D is not an artifact and corresponds to an actual molecule or molecule fragment.

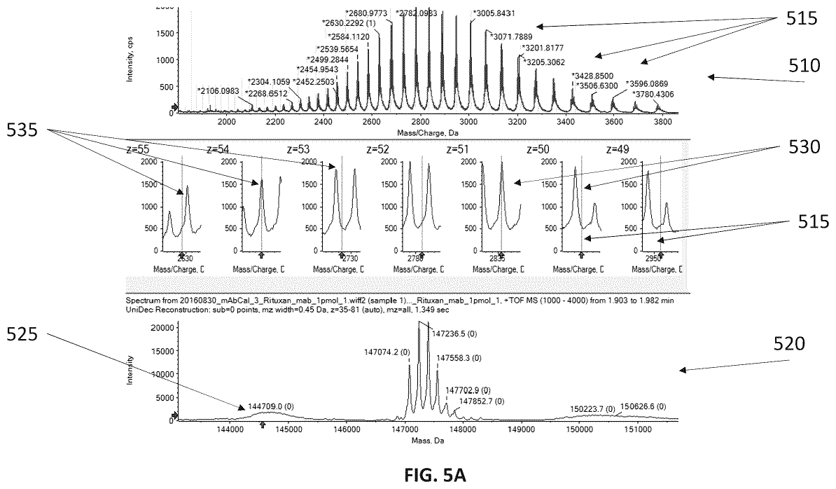

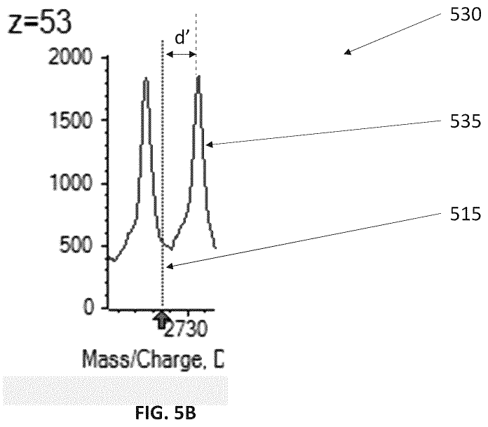

FIGS. 5A-5B are illustrations of another peak analysis display, according to various aspects. In FIG. 5A, similarly to FIG. 4A, the charge series spectrum 510 is displayed, with markers 515 indicating the various charges overlayed thereon. Also in FIG. 5A, the reconstructed spectrum 520 is displayed. In various aspects, when one of the peaks in the reconstructed spectrum 520 such as, e.g., reconstructed peak 525, is selected by a user, a plurality of icons 530 may be displayed, each icon 530 displaying a charge series peak 535 and a corresponding marker 515. In various aspects, the user may visually examine each icon 530 to determine whether the charge series peaks 535 coincide with their corresponding markers 515, as further discussed below.

FIG. 5B shows a magnified view of one of the icons 530. In various aspects, the icon 530 illustrated in FIG. 5B shows that the charge series peaks 535 and the marker 515 do not coincide with each other because, e.g., the distance d′ separating the charge series peak 535 and its corresponding marker 515 is too large upon visual examination. In addition, instead of a single charge series peak 535 being in the vicinity of the marker 515, there are two charge series peaks 535 located on each side of the marker 515, and neither one of the two charge series peaks 535 coincides with the marker 515. In this case, the user may conclude that the charge series peaks 535 and the marker 515 do not coincide, and determine on this basis that the reconstructed peak 525 selected from the reconstructed spectrum 520 in FIG. 5A does not correspond to a molecule, or to a molecule fragment, and that it is in fact an artifact.

In other aspects, instead of relying on a visual examination by the user, the distance d′ between one of the charge series peaks 535 and the marker 515 may be measured and compared to a predetermined or desired threshold distance that defines the coincidence between the charge series peak 535 and the marker 515. In this case, the distance d′ between the charge series peak 535 and the marker 515 is greater than the threshold, and a determination may be made based on the calculation of the distance d′, without visual evaluation by the user, than the charge series peaks 535 and the marker 515 do not coincide, and thus that the reconstructed peak 525 selected from the reconstructed spectrum 520 in FIG. 5A does not correspond to a molecule, or to a molecule fragment, and that it is in fact an artifact. In various other aspects, the above evaluation may also be performed for each of the icons 530 displayed in FIG. 5A without awaiting a selection of a peak by a user.

In various aspects, the plurality of icons 530 illustrated in FIG. 5A may have different levels of coincidence between the charge series peaks 535 and the markers 515. For example, some of the icons 530 may include peaks charge series 535 and markers 515 that coincide with each other, e.g., for which the distance separating them is equal to or below the threshold. However, other icons 530 may include charge series peaks 535 that do not coincide with their corresponding markers 515. In various aspects, as long as at least one of the icons 530 includes a charge series peak 535 and marker 515 that do not coincide, it may be possible to conclude that the reconstructed peak 525 that corresponds to the icons 530 does not identify a molecule or a molecule fragment, and is instead an artifact.

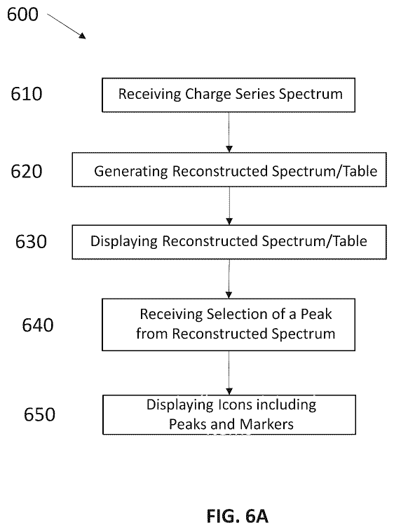

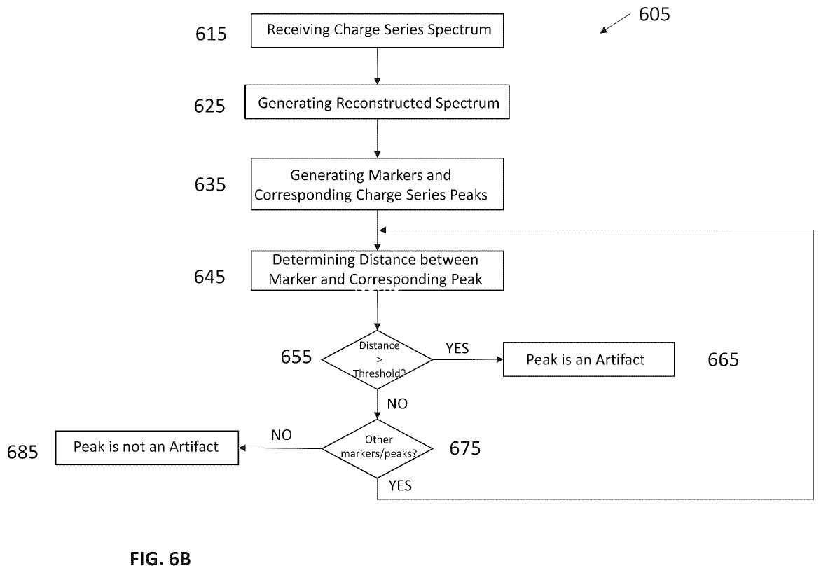

FIGS. 6A-6B are flow charts depicting methods for analyzing a mass spectrometry spectrum, in accordance with various embodiments described herein. For the sole purpose of convenience, methods 600 and 605 are described through use of the example mass spectrometer 100 and controlled by a computing device such as the computing device 700 further discussed below.

Method 600 includes at least operations 610 to 640. Operation 610 includes receiving a charge series spectrum such as, e.g., the charge series spectrum 200 illustrated in FIG. 2, the charge series spectrum 200 including a plurality of charge series peaks 210. In various aspects, after being received, the charge series spectrum may be displayed to a user on a portion of a display screen. Alternatively, the charge series spectrum may be stored in a memory without being displayed on a display screen, the memory being, e.g., included in the computing device 700 further discussed below.

Operation 620 includes generating a reconstructed spectrum. Specifically, a reconstructed spectrum is generated based on the received charge series spectrum by calculating the mass “m” of the molecules or molecule fragments based on the mass-to-charge ratio “m/z” and each individual charge “z,” then plotting the intensity of the received signal as a function of the calculated mass of the molecules or molecule fragments. In various aspects, instead of generating a plot of the intensity as a function of the mass of the molecules or molecule fragments, operation 620 may include generating a list of the peaks of the reconstructed spectrum and their corresponding intensities.

Operation 630 includes, in various aspects, after determining the reconstructed spectrum, displaying the reconstructed spectrum on a portion of the display screen that is, e.g., separate from the portion where the charge series spectrum is displayed, as illustrated in, e.g., FIG. 4A. In various aspects, instead of displaying a plot of the reconstructed spectrum, operation 630 may include displaying a table including the list of reconstructed peak and their intensities determined during operation 620, as illustrated in, e.g., FIG. 4D.

Operation 640 includes receiving a selection of one of the reconstructed peaks from the reconstructed peak spectrum generated during operation 620 and displayed during operation 630. For example, a user may select a reconstructed peak via a graphical user interface (GUI) on the display screen. In various aspects, when a table is displayed during operation 630, the table including a list of the mass values of each reconstructed peak and their corresponding intensities, operation 640 may include receiving a selection of one of the mass values from the list.

Based on the received selection of a reconstructed peak during operation 640, operation 650 includes displaying a plurality of markers overlaying the charge series spectrum. For example, each marker corresponds to a charge of the charge series spectrum and is overlaid over a corresponding charge series peak of the charge series spectrum. In various aspects, operation 650 also includes displaying a plurality of icons on a third portion of the display screen, each icon including a charge series peak and its corresponding marker, the charge series peaks and markers corresponding to the selected reconstructed peak. In various aspects, operation 650 includes displaying a central icon that has the highest received signal intensity, and the remaining icons in decreasing charge on one side and in increasing charge on another side of the central icon.

In various aspects, when the icons are displayed, a user may be able to visually determine whether the charge series peak and the marker are coincident with each other. For example, the user may determine that the charge series peak and the marker coincide with each other when a separation between them is smaller than a percentage of the width of the charge series peak such as, e.g., less than 25% of a width of the charge series peak. In other aspects, the user may determine that the charge series peak and the marker coincide with each other when a separation between them is smaller than a percentage of the full width at half-maximum (FWHM) of the charge series peak such as, e.g., less than 25% of the FWHM. In various aspects, if any of the icons corresponding to a selected reconstructed peak show that the charge series peak and the marker do not coincide with each other, then it may be concluded that the selected reconstructed peak is an artifact.

Method 605 includes at least operations 615 to 685. Operation 615 includes receiving a charge series spectrum such as, e.g., the charge series spectrum illustrated in FIG. 2, the charge series spectrum including a plurality of charge series peaks. For example, after being received, the charge series spectrum may be displayed to a user on a portion of a display screen. Alternatively, the charge series spectrum may be stored in a memory without being displayed to the user, the memory being, e.g., included in the computing device 700 further discussed below.

Operation 625 includes generating a reconstructed spectrum. Specifically, a reconstructed spectrum is determined based on the received charge series spectrum by calculating the mass “m” of the molecules or molecule fragments based on the mass-to-charge ratio “m/z” and the charge “z,” then plotting the intensity of the received signal as a function of the calculated mass of the molecules or molecule fragments. In various aspects, instead of determining a plot of the intensity as a function of the mass of the molecules or molecule fragments, operation 625 may include generating a list of the reconstructed peaks of the reconstructed spectrum and their corresponding intensities, as illustrated, e.g., in FIG. 4D.

Operation 635 includes, for each one of the mass values of the reconstructed spectrum, or each one of the peaks listed in the reconstructed list generated in operation 625, generating a plurality of markers. In various aspects, each marker corresponds to a charge of the charge series spectrum and has a corresponding charge series peak.

Operation 645 includes determining, for each reconstructed peak, a distance between the markers and the charge series peaks corresponding to the reconstructed peak. In various aspects, the distance, illustrated as “d” and d′ in FIGS. 4C and 5B, is determined based on the respective positions of the marker and of the charge series peak on the mass/charge ratio axis. In other aspects, the distance is determined based on the respective values of the mass/charge ratio of the marker and of the charge series peak listed in a table such as the table illustrated in FIG. 4E.

Operation 655 includes determining whether the distance determined during operation 645 is greater than a predetermined or desired threshold. In various aspects, when the determined distance is greater than the threshold for any of the charge series peaks corresponding to a reconstructed peak, during operation 665, a determination is made that the reconstructed peak is a probable or likely artifact and does not correspond to a molecule or a molecule fragment. In various aspects, when the determined distance is equal to or smaller than the threshold, then during operation 675, a determination is made whether there are other charge series peaks corresponding to the reconstructed peak that have not yet been examined. If there is another charge series peak corresponding to the reconstructed peak that has not yet been examined, then operation returns to operation 645 to examine the charge series peak and the corresponding marker thereof. If operation 675 determines that there are no other charge series peaks to examine, then operation 685 includes determining that the reconstructed peak is probably or likely not an artifact and instead corresponds to a molecule or a molecule fragment.

In various aspects, if any of the charge series peaks that correspond to a reconstructed peak do not coincide with their respective marker, then it can be determined that the reconstructed peak is an artifact, even if some of the charge series peaks coincide with their marker.

FIG. 7 depicts a block diagram of a computing device configured to control the example mass spectrometer 100 discussed above with respect to FIG. 1. In the illustrated example, the computing device 700 may include a bus 702 or other communication mechanism of similar function for communicating information, and at least one processing element 704 (collectively referred to as processing element 704) coupled with bus 702 for processing information. As will be appreciated by those skilled in the art, the processing element 704 may include a plurality of processing elements or cores, which may be packaged as a single processor or in a distributed arrangement. Furthermore, a plurality of virtual processing elements 704 may be included in the computing device 700 to provide the control or management operations for the example mass spectrometer 100 illustrated above.

The computing device 700 may also include one or more volatile memory(ies) 706, which can for example include random access memory(ies) (RAM) or other dynamic memory component(s), coupled to one or more busses 702 for use by the at least one processing element 704. Computing device 700 may further include static, non-volatile memory(ies) 708, such as read only memory (ROM) or other static memory components, coupled to busses 702 for storing information and instructions for use by the at least one processing element 704. A storage component 710, such as a storage disk or storage memory, may be provided for storing information and instructions for use by the at least one processing element 704. As will be appreciated, the computing device 700 may include a distributed storage component 712, such as a networked disk or other storage resource available to the computing device 700.

The computing device 700 may be coupled to one or more displays 714 for displaying information to a user. Optional user input device(s) 716, such as a keyboard and/or touchscreen, may be coupled to Bus 702 for communicating information and command selections to the at least one processing element 704. An optional cursor control or graphical input device 718, such as a mouse, a trackball or cursor direction keys for communicating graphical user interface information and command selections to the at least one processing element. The computing device 700 may further include an input/output (I/O) component, such as a serial connection, digital connection, network connection, or other input/output component for allowing intercommunication with other computing components and the various components of the example mass spectrometer 100 discussed above.

In various embodiments, computing device 700 can be connected to one or more other computer systems via a network to form a networked system. Such networks can for example include one or more private networks or public networks, such as the Internet. In the networked system, one or more computer systems can store and serve the data to other computer systems. The one or more computer systems that store and serve the data can be referred to as servers or the cloud in a cloud computing scenario. The one or more computer systems can include one or more web servers, for example. The other computer systems that send and receive data to and from the servers or the cloud can be referred to as client or cloud devices, for example. Various operations of the example mass spectrometer 100 may be supported by operation of the distributed computing systems.

The computing device 700 may be operative to control operation of the components of the example mass spectrometer 100 through a communication device such as, e.g., communication device 720, and to handle data generated by components of the example mass spectrometer 100. In some examples, analysis results are provided by the computing device 700 in response to the at least one processing element 704 executing instructions contained in memory 706 or 708 and performing operations on data received from the example mass spectrometer 100. Execution of instructions contained in memory 706 and/or 708 by the at least one processing element 704 can render the example mass spectrometer 100 and associated sample delivery components operative to perform methods described herein.

The term “computer-readable medium” as used herein refers to any media that participates in providing instructions to the processing element 704 for execution. Such a medium may take many forms, including but not limited to, non-volatile media, volatile media, and transmission media. Non-volatile media includes, for example, optical or magnetic disks, such as disk storage 710. Volatile media includes dynamic memory, such as memory 706. Transmission media includes coaxial cables, copper wire, and fiber optics, including the wires that include bus 702.

Common forms of computer-readable media or computer program products include, for example, a floppy disk, a flexible disk, hard disk, magnetic tape, or any other magnetic medium, a CD-ROM, digital video disc (DVD), a Blu-ray Disc, any other optical medium, a thumb drive, a memory card, a RAM, PROM, and EPROM, a FLASH-EPROM, any other memory chip or cartridge, or any other tangible medium from which a computer can read.

Various forms of computer readable media may be involved in carrying one or more sequences of one or more instructions to the processing element 704 for execution. For example, the instructions may initially be carried on the magnetic disk of a remote computer. The remote computer can load the instructions into its dynamic memory and send the instructions over a telephone line using a modem. A modem local to computing device 700 can receive the data on the telephone line and use an infra-red transmitter to convert the data to an infra-red signal. An infra-red detector coupled to bus 702 can receive the data carried in the infra-red signal and place the data on bus 702. Bus 702 carries the data to memory 706, from which the processing element 704 retrieves and executes the instructions. The instructions received by memory 706 and/or memory 708 may optionally be stored on storage device 710 either before or after execution by the processing element 704.

In accordance with various embodiments, instructions operative to be executed by a processing element to perform a method are stored on a computer-readable medium. The computer-readable medium can be a device that stores digital information. For example, a computer-readable medium includes a compact disc read-only memory (CD-ROM) as is known in the art for storing software. The computer-readable medium is accessed by a processor suitable for executing instructions configured to be executed.

This disclosure described some examples of the present technology with reference to the accompanying drawings, in which only some of the possible examples were shown. Other aspects can, however, be embodied in many different forms and should not be construed as limited to the examples set forth herein. Rather, these examples were provided so that this disclosure was thorough and complete and fully conveyed the scope of the possible examples to those skilled in the art.

Although specific examples were described herein, the scope of the technology is not limited to those specific examples. One skilled in the art will recognize other examples or improvements that are within the scope of the present technology. Therefore, the specific structure, acts, or media are disclosed only as illustrative examples. Examples according to the technology may also combine elements or components of those that are disclosed in general but not expressly exemplified in combination, unless otherwise stated herein. The scope of the technology is defined by the following claims and any equivalents therein.

What is claimed is:

1. A method of displaying a charge series spectrum, the method comprising:
receiving the charge series spectrum, the charge series spectrum including a plurality of charge series peaks;
determining one or more reconstructed mass values based at least in part on the received charge series spectrum;
displaying the one or more reconstructed mass values on a first portion of a display; receiving a selection of one of the displayed reconstructed mass values; and
displaying a plurality of icons on a second portion of the display, each icon including a marker and a corresponding charge series peak thereof, the marker identifying a charge of the charge series spectrum.

2. The method of claim 1, further comprising displaying the charge series spectrum on a third portion of the display.

3. The method of claim 1, wherein displaying the plurality of icons comprises displaying each icon with an enlarged view of the marker and of the corresponding peak thereof compared to the charge series spectrum.

4. The method of claim 1, wherein displaying the one or more reconstructed mass values comprises displaying a reconstructed spectrum, the reconstructed spectrum including reconstructed peaks corresponding to the one or more reconstructed mass values.

5. The method of claim 1, wherein displaying the one or more reconstructed mass values comprises displaying a list of the one or more reconstructed mass values and their corresponding signal intensities.

6. (canceled)

7. The method of claim 1, further comprising determining that the selected reconstructed mass value is a probable artifact when the marker does not coincide with a local maximum of the corresponding charge series peak thereof in at least one of the plurality of icons.

8. The method of claim 1, further comprising displaying a reconstructed spectrum on the display without the artifact.

9. (canceled)

10. The method of claim 1, wherein determining that the marker does not coincide with the local maximum of the corresponding charge series peak comprises determining that a separation between the marker and the local maximum of the corresponding charge series peak is greater than a percentage of a width of the corresponding charge series peak.

11. (canceled)

12. The method of claim 1, wherein determining that the marker does not coincide with the local maximum of the corresponding charge series peak comprises determining that a separation between the marker and the local maximum of the corresponding charge series peak is greater than a percentage of a full width at half-maximum of the corresponding charge series peak.

13. (canceled)

14. The method of claim 1, wherein a corresponding peak of the central icon has a highest signal intensity compared to corresponding peaks of the other icons.

15. A mass spectrometry data display apparatus comprising:
a data receiver;
a display device functionally coupled to the data receiver, the display device comprising a display screen;
a processor operatively coupled to the data receiver and to the display device; and
a memory coupled to the processor, the memory storing instructions that, when executed by the processor, perform a set of operations comprising:
receiving, at the data receiver, a charge series spectrum including a plurality of charge series peaks;
generating, via the processor, one or more reconstructed mass values based at least in part on the received charge series spectrum;
displaying the one or more reconstructed mass values on a first portion of the display screen;
receiving, at the display screen, a selection of one of the displayed reconstructed mass values; and
displaying a plurality of icons on a second portion of the display screen, each icon including a marker and a corresponding charge series peak thereof, the marker identifying a charge of the charge series spectrum.

16. The mass spectrometry data display apparatus of claim 15, wherein displaying the one or more reconstructed mass values comprises displaying a reconstructed spectrum, the reconstructed spectrum including reconstructed peaks corresponding to the one or more reconstructed mass values.

17. The mass spectrometry data display apparatus of claim 15, wherein displaying the one or more reconstructed mass values comprises displaying a list of the one or more reconstructed mass values and their corresponding signal intensities.

18. The mass spectrometry data display apparatus of claim 15, wherein the set of operations further comprises determining, via the processor, that the selected reconstructed mass value is a probable artifact when the marker does not coincide with a local maximum of the corresponding charge series peak thereof in at least one of the plurality of icons.

19. The mass spectrometry data display apparatus of claim 15, wherein the set of operations further comprises displaying a reconstructed spectrum on the display screen without the artifact.

20. The mass spectrometry data display apparatus of claim 15, wherein the set of operations further comprise displaying a list of the one or more reconstructed mass values and their corresponding signal intensities on the display screen, the list omitting the artifact.

21. The mass spectrometry data display apparatus of claim 15, wherein the set of operations comprises determining, via the processor, that the marker does not coincide with the local maximum of the corresponding charge series peak when a separation between the marker and the local maximum of the corresponding charge series peak is greater than a percentage of a width of the corresponding peak.

22. The mass spectrometry data display apparatus of claim 15, wherein the set of operation comprises displaying, on the display screen, each icon on the display screen with an enlarged view of the marker and of the corresponding peak thereof compared to the charge series spectrum.

23. The mass spectrometry data display apparatus of claim 15, wherein:
displaying the plurality of icons comprises displaying a central icon and other icons in proximity to the central icon; and
a corresponding charge series peak of the central icon has a highest signal intensity compared to corresponding charge series peaks of the other icons.

24. A method of evaluating a quality of a charge series spectrum, the method comprising:
receiving the charge series spectrum, the charge series spectrum including a plurality of charge series peaks;
generating one or more reconstructed mass values based at least in part on the received charge series spectrum; and
for each reconstructed mass value:
generating a plurality of markers, each marker corresponding to a charge of the charge series and having a corresponding charge series peak thereof from the charge series spectrum; and
determining that the reconstructed mass value is a probable artifact when a difference between at least one of the plurality of markers and a local maximum of the corresponding charge series peak thereof is greater than a threshold.

25-30. (canceled)
